(19) United States
(12) Patent Application Publication
(10) Pub. No.: US 2007/0060050 A1
(43) Pub. Date: Mar. 15, 2007

(54) Apparatus and method for supporting multi-link in multi-hop relay cellular network

(75) Inventors: Mi-Hyun Lee, Seoul (KR); Pan-Yuh Joo, Seoul (KR); Jung-Je Son, Seongnam-si (KR); Jae-Weon Cho, Suwon-si (KR); Hyoung-Kyu Lim, Seoul (KR); Yeong-Moon Son, Anyang-si (KR); Sung-Jin Lee, Seoul (KR); Hyun-Jeong Kang, Seoul (KR); Song-Nam Hong, Seoul (KR); Young-Ho Kim, Suwon-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/521,420

(22) Filed: Sep. 14, 2006

(30) Foreign Application Priority Data
Sep. 14, 2005 (KR) 10-2005-0085916

(51) Int. Cl. H04B 7/185

(52) U.S. Cl. 455/13.1

(57) ABSTRACT

Provided is an apparatus and method for constructing a frame for transmitting a direct link and a multi-hop relay link signal in one frame in a multi-hop relay cellular network. The signals are multiplexed on a time-division multiplexing basis and a base station downlink and relay station uplink subframe are located in a conventional downlink subframe. Accordingly, the overhead for a relay station receive transition gap in the downlink subframe and a relay station transmit transition gap in the conventional uplink subframe are eliminated.

### PRIORITY

This application claims priority under 35 U.S.C. § 119 to an application entitled “Apparatus and Method for Supporting Multi-Link in Multi-Hop Relay Cellular Network” filed in the Korean Intellectual Property Office on Sep. 14, 2005 and assigned Ser. No. 2005-85916, the contents of which are incorporated herein by reference.

### BACKGROUND OF THE INVENTION

1. Field of the Invention

The present invention relates generally to a multi-hop relay cellular network, and in particular, to a method for constructing a frame for supporting multi-link resources in a multi-hop relay cellular network and a transmitting/receiving apparatus for supporting the method.

2. Description of the Related Art

Nowadays, it is popular for people to carry a variety of digital electronic devices such as notebook computers, portable phones, personal data assistants (PDAs) and MP3 players. The portable digital electronic devices generally operate independently and without interacting with one another. A wireless network configured of only the portable digital electronic devices, without a central control system, would allow these devices to easily interact and share data, making possible a variety of novel data communication services. A wireless network capable of providing such interactive communication between devices without the aid of a central control system is called “ad-hoc network” or “ubiquitous network”.

Research is being actively conducted on the fourth-generation (4G) mobile communication system, and a self-configurable wireless network is one of the most important requirements for this system.

The self-configurable wireless network enables a mobile communication service by configuring a wireless network independent of a central control system. In the 4G mobile communication system, a plurality of cells each having a very small radius are installed to provide high-rate data communication and accommodate a large amount of traffic. In the 4G system, it is impossible to implement a centralized network using the existing wireless network design. A 4G wireless network must account for an environment change such as an addition of new base stations (BSs), and requires the self-configurable wireless network.

An example of technology implemented for the ad-hoc network for the self-configurable wireless network is a multi-hop relay cellular network in which a multi-hop relay scheme is introduced in a cellular network configured with a stationary BS.

In the cellular network, it is possible to easily establish a high-reliability wireless communication link between a BS and a mobile station (MS) because communication between the BS and the MS is performed through one direct link.

However, because the BS is stationary, the cellular network is inflexible as to a wireless network construction, making it difficult to provide an efficient service in a high traffic and adaptive environment.

To overcome this difficulty, a relay scheme is used that transmits data in a multi-hop fashion through neighboring MS or relay stations (RSs). The multi-hop relay scheme enables rapid reconstruction of a network suitable for peripheral environments and efficient operation throughout the entire wireless network. Therefore, the self-configurable wireless network required in the 4G mobile communication system can be modeled after the multi-hop relay cellular network. Moreover, the multi-hop relay scheme can be used to provide a high-rate data channel to MSs located in a shadow area where the MSs cannot communicate directly with a BS, thereby enabling expansion of a cell coverage area.

FIG. 1 is a diagram illustrating the structure of a conventional multi-hop relay cellular network.

Referring to FIG. 1, a mobile station (MS) 110 located inside a coverage area 101 of a base station (BS) 100, communicates directly with the BS 100. An MS 120 located outside the coverage area 101 and thus having poor channel conditions, communicates indirectly with the BS 100 through a relay station (RS) 130.

When an MS communicates directly with the BS 100 but has poor channel conditions because it is located at the edge of the BS coverage area 101, the RS 130 can be used to provide a better radio channel. Therefore, using a multi-hop relay scheme, the BS 100 can provide a high-rate data channel in a cell boundary region with a poor channel condition and thus can expand a cell service area (i.e., the coverage area 101).

It is necessary to provide a frame structure capable of supporting a direct link and a relay link in one frame so that the MS can communicate with the RS 130 as well as the BS.

FIG. 2 is a diagram illustrating the structure of a frame for the conventional cellular network. Throughout the following description, the abscissa represents a time domain and the ordinate represents a frequency domain.

Referring to FIG. 2, the frame is divided into a downlink (DL) subframe 201 and an uplink (UL) subframe 211. The DL subframe 201 includes a BS preamble 203, a first zone 205 containing UL/DL burst allocation information, and a DL burst 207 allocated for DL data.

The UL subframe 211 includes a BS ranging field 213 containing a signal that an MS uses to communicate with a BS and a UL burst 215 allocated for UL data.

In addition, a Transmit/Receive Transition Gap (TTG) 210, which is a guard region, is interposed between the DL subframe 201 and the UL subframe 211, and a Receive/Transmit Transition Gap (RTG) 209 is located before the DL subframe 201.

FIG. 3 is a diagram illustrating the structure of a frame for a conventional multi-hop relay cellular network. Referring to FIG. 3, the frame is divided into a BS DL subframe 301 for a BS, an RS DL subframe 311 for an RS, a BS UL subframe 321 for the BS and an RS UL subframe 331 for the RS.

The BS DL subframe 301 includes a BS preamble 303, a first zone 305 containing UL/DL burst allocation information and a DL burst 307 allocated for DL data. The first zone 305 includes burst allocation information of both the BS and the RS.

The RS DL subframe 311 includes an RS preamble 313 and an RS DL burst 315 allocated for DL data of the RS.

The BS UL subframe 321 includes a BS ranging field 323 containing a signal that an MS uses to communicate with the BS and a BS UL burst 325 allocated for UL data of the MS.

The RS UL subframe 331 includes an RS ranging field 333 containing a signal that the MS uses to communicate with the RS and an RS UL burst 335 allocated for UL data of the MS.

In addition, an RS Receive/Transmit Transition Gap (RTG) 310, 320 and 330, which is a guard region, is interposed between the BS DL subframe 301 and the RS DL subframe 311, the RS DL frame 311 and the BS UL subframe 321 and the BS UL subframe 321 and the RS UL 331, respectively.

FIG. 4 is a diagram illustrating a procedure for transmitting/receiving signals in the conventional multi-hop relay cellular network.

Referring to FIG. 4, when a BS 401 transmits a BS DL subframe, an RS 403 and an MS_{RS} 407 receive the BS DL subframe of the BS 401. At this point, an MS_{RS} 405 may receive a preamble signal of the BS 401. Thereafter, a guard region RS RTG follows.

When the RS 403 transmits a RS DL subframe, the MS_{RS} 405 receives the RS DL subframe. Thereafter, a guard region TTG follows. When the RS 403 and the MS_{RS} 407 transmits a BS UL subframe and the BS 401 receives the BS UL sub frame. Thereafter, a guard region RS RTG follows. The MS_{RS} 405 transmits RS UL subframe to the RS 403 and the RS 403 receives a TX signal of the MS_{RS} 405.

As described above, the RS switches between the UL/DL subframes in the frame, causing overheads for the RS RTG and TTG and a waste of resources.

FIG. 5 is a diagram illustrating the structures of UL/DL subchannels in a conventional cellular network.

Referring to FIG. 5, in the case of the symbol structure for a downlink with one transmitting end, all the pilot subcarriers among all available subcarriers are first mapped and then the remaining subcarriers are mapped to subchannels in accordance with a selected permutation. That is, the DL symbol structure is divided into one pilot subchannel and a plurality of subchannels according to the permutation.

In the case of the symbol structure for an uplink with a plurality of transmitting ends, all pilot subcarriers among all available subcarriers are first mapped and a selected region (time×frequency) containing the pilot subcarriers is divided into a plurality of sections that are mapped to one subchannel. That is, the UL symbol structure is configured such that a plurality of pilot subcarriers are contained in one subchannel.

As illustrated in FIG. 5, because channel estimation is performed on each transmitting end for coherent demodulation of a signal in a data region, a pilot subcarrier is necessary for each transmitting end. A transmitting end in the downlink is one BS, so that the downlink has a subchannel-independent pilot subcarrier structure as described above. However, because coherent demodulation is performed on a data region allocated to different transmitting ends, the uplink has a pilot subcarrier structure depending on subchannels in the allocated data region.

As described above, a plurality of RSs may belong to one BS and resource allocation for an RS downlink requires a symbol structure where a pilot is contained in a corresponding region.

FIG. 6 is a diagram illustrating a change in a subframe length depending on cell loads in the conventional multi-hop relay cellular network.

In FIG. 6, the length of a BS DL subframe may substantially vary depending on cell loads and the start point of an RS DL subframe may also vary. Since the position of the RS preamble 313 of the RS DL subframe may vary per frame, it is difficult to obtain initial synchronization of an MS that must have an RS relay link.

### SUMMARY OF THE INVENTION

An object of the present invention is to substantially solve at least the above problems and/or disadvantages and to provide at least the advantages below. Accordingly, an object of the present invention is to provide a method for constructing a frame for supporting a multi-link in a multi-hop relay cellular network and a transmitting/receiving apparatus for supporting the method.

Another object of the present invention is to provide a method for constructing a frame for fixing the position of a preamble of a relay link in a multi-hop relay cellular network and a transmitting/receiving apparatus for supporting the method.

A further object of the present invention is to provide a method for constructing a frame for synchronizing the operations of RSs to support a multi-link in a multi-hop relay cellular network and a transmitting/receiving apparatus for supporting the method.

According to the present invention, there is provided an RS transmitter for transmitting a direct link and a multi-hop relay link in one frame in a multi-hop relay cellular network, the RS transmitter including a frame constructor for constructing frames to be transmitted to the MS and BS by sequentially positioning a ranging signal, a preamble, a DL burst to be transmitted to an MS and a UL burst to be transmitted to a base station (BS), and a timing controller for providing a timing signal indicating the time to transmit the constructed frames to the MS and the BS.

According to the present invention, there is provided an RS receiver for receiving a direct link and a multi-hop relay link in one frame in a multi-hop relay cellular network, the RS receiver including a frame extractor for extracting a BS preamble, BS DL control information, BS DL data, an RS UL burst and an RS ranging signal from a DL subframe received from the BS and a UL subframe received from an MS, and a timing controller for providing a timing signal for determining whether the DL subframe and the UL subframe are received through a direct link or a relay rink.

According to the present invention, there is provided a method for transmitting signals from an RS in order to transmit a direct link and a multi-hop relay link in one frame in a Time-Division Multiplexed (TDM) multi-hop relay cellular network, including transmitting a ranging signal to a BS, transmitting a DL subframe to an MS after the transmission of the ranging signal, transmitting a UL subframe to the BS after the transmission of the DL subframe, and switching into a Receiving (RX) mode after the transmission of the UL subframe.

According to the present invention, there is provided a method for receiving signals at an RS in order to transmit a direct link and a multi-hop relay link in one frame in a multi-hop relay cellular network, including determining whether a DL subframe is received from a BS, determining whether a UL subframe is received from an MS if the DL subframe is received, and switching into a Transmission (TX) mode if the UL subframe is received.

According to the present invention, there is provided a method for constructing a frame for supporting a direct link and a multi-hop relay link in a multi-hop relay cellular network, including constructing a first subframe for performing an RX operation of an RS during a first section of the frame, and constructing a second subframe for performing a TX operation of an RS during a second section of the frame.

### BRIEF DESCRIPTION OF THE DRAWINGS

The above and other objects, features, and advantages of the present invention will become more apparent from the following detailed description when taken in conjunction with the accompanying drawings in which:

FIG. 1 is a block diagram of a conventional multi-hop relay cellular network;

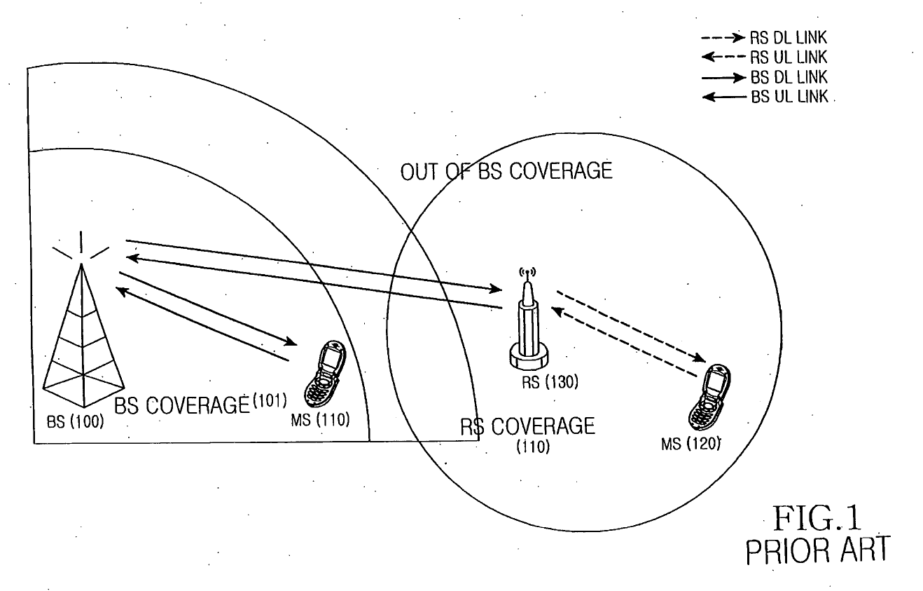

FIG. 2 is a diagram illustrating the structure of a frame for the conventional cellular network;

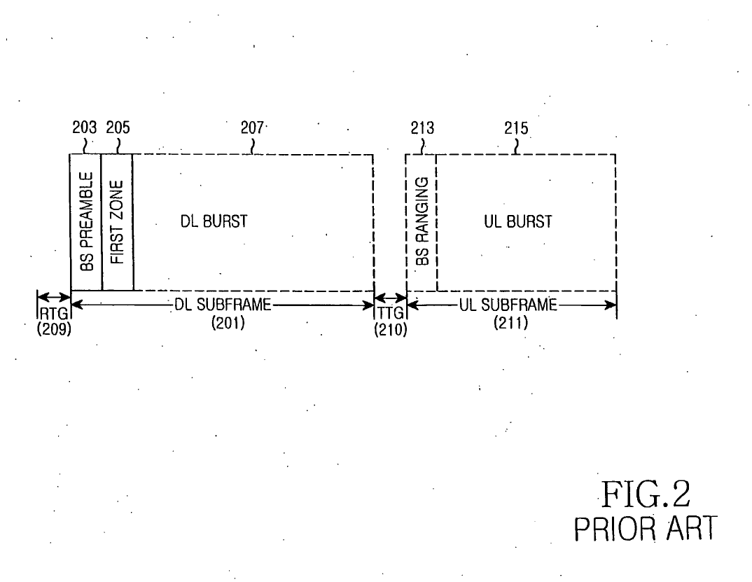

FIG. 3 is a diagram illustrating the structure of a frame for a conventional multi-hop relay cellular network;

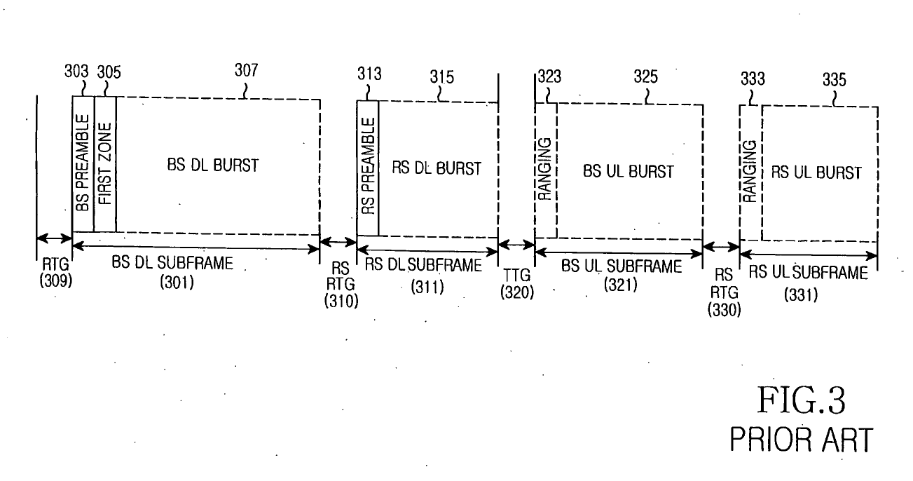

FIG. 4 is a diagram illustrating a procedure for transmitting/receiving signals in the conventional multi-hop relay cellular network;

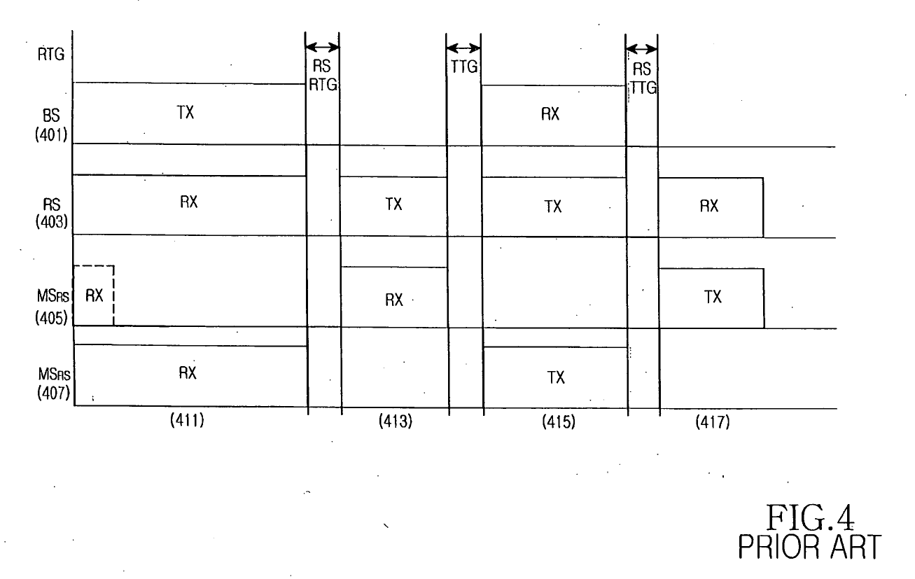

FIG. 5 is a diagram illustrating the structures of UL/DL subchannels in a conventional cellular network;

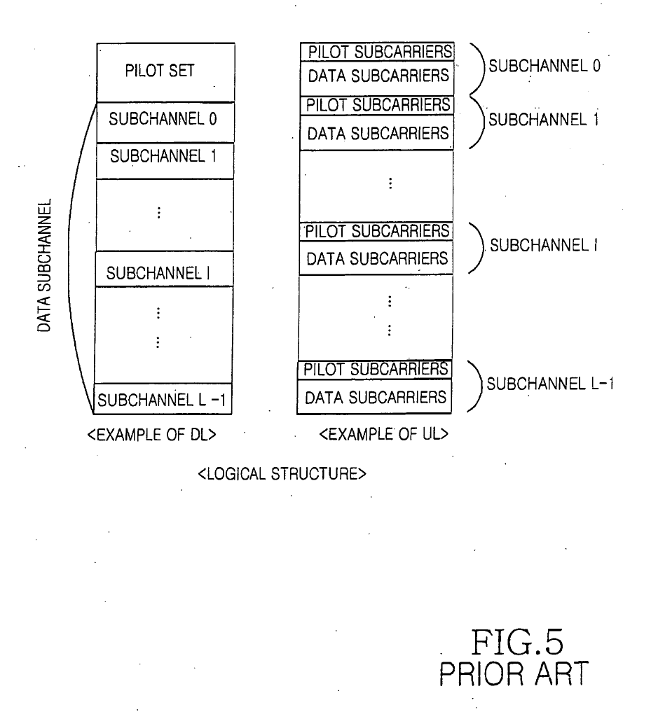

FIG. 6 is a diagram illustrating a change in a subframe length depending on cell loads in the conventional multi-hop relay cellular network;

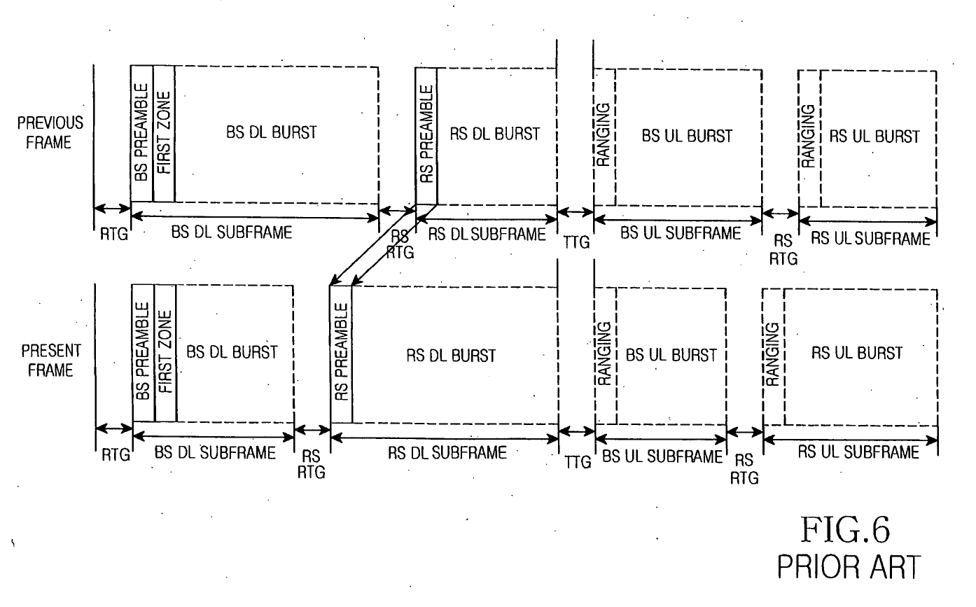

FIG. 7 is a diagram illustrating the structure of a frame for a TDM-based multi-hop relay cellular network according to the present invention;

FIG. 8 is a diagram illustrating the structure of a frame for constructing a spatial multiplexing RS link in a TDM-based multi-hop relay cellular network according to the present invention;

FIG. 9 is a diagram of a spatial multiplexing multi-hop relay cellular network according to the present invention;

FIG. 10 is a diagram illustrating a procedure for transmitting signals in a TDM-based multi-hop relay cellular network according to the present invention;

FIG. 11 is a diagram illustrating the structure of a frame for a hybrid multiplexing scheme based multi-hop relay cellular network according to the present invention;

FIG. 12 is a diagram illustrating the structure of a frame for constructing a spatial multiplexing RS link in a hybrid multiplexing scheme based multi-hop relay cellular network according to the present invention;

FIG. 13 is a diagram illustrating a procedure for transmitting/receiving signals in a hybrid multiplexing scheme based multi-hop relay cellular network according to the present invention;

FIG. 14 is a flow diagram illustrating a procedure for transmitting signals from a BS according to the present invention;

FIG. 15 is a block diagram of a transmitter of a BS according to the present invention;

FIG. 16 is a flow diagram illustrating a procedure for receiving signals at a BS according to the present invention;

FIG. 17 is a block diagram of a receiver of a BS according to the present invention;

FIG. 18 is a flow diagram illustrating a procedure for receiving signals at an RS according to the present invention;

FIG. 19 is a block diagram of a receiver of an RS according to the present invention;

FIG. 20 is a flow diagram illustrating a procedure for transmitting signals from an RS using a TDM frame structure according to the present invention;

FIG. 21 is a block diagram of a transmitter of an RS using a TDM frame structure according to the present invention;

FIG. 22 is a flow diagram illustrating a procedure for transmitting signals from an RS using a Frequency-Division Multiplexing (FDM) frame structure according to the present invention;

FIG. 23 is a flow diagram illustrating a procedure for transmitting signals from an MS to an RS according to the present invention;

FIG. 24 is a block diagram of an MS transmitter for transmitting signals to an RS according to the present invention;

FIG. 25 is a flow diagram illustrating a procedure for receiving signals at an MS from an RS according to the present invention;

FIG. 26 is a block diagram of an MS receiver for receiving signals from an RS according to the present invention;

FIG. 27 is a flow diagram illustrating a procedure for transmitting signals from an MS to a BS according to the present invention;

FIG. 28 is a block diagram of an MS transmitter for transmitting signals to a BS according to the present invention;

FIG. 29 is a flow diagram illustrating a procedure for receiving signals at an MS from a BS according to the present invention;

FIG. 30 is a block diagram of an MS receiver for receiving signals from a BS according to the present invention;

FIG. 31 is a diagram illustrating the structure of a BS DL subframe according to the present invention;

FIG. 32 is a diagram illustrating the structure of an RS UL subframe according to the present invention;

FIG. 33 is a diagram illustrating the structure of a burst of the RS UL subframe according to the present invention;

FIG. 34 is a diagram illustrating the structure of an RS DL subframe according to the present invention;

FIG. 35 is a diagram illustrating the structure of a BS UL subframe according to the present invention;

FIG. 36 is a diagram illustrating the structure of a hybrid UL subframe according to the present invention;

FIG. 37 is a diagram of a 3-hop relay cellular network according to the present invention; and

FIG. 38 is a diagram illustrating a frame structure capable of supporting a multi-hop structure according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail for the sake of clarity and conciseness.

The present invention is directed to a method for constructing a frame for supporting a multi-link in a multi-hop relay cellular network and a transmitting/receiving apparatus for supporting the method. Hereinafter, an MS connected to a BS through a direct link will be referred to as “MS_{BS}”, and an MS connected to a BS through a multi-hop relay link using an RS will be referred to as “MS_{RS}”. The direct link refers to a communication link for directly communicating with the BS, and the relay link refers to a communication link for indirectly communicating with the BS through the RS.

A wireless communication system using an Orthogonal Frequency Division Multiple Access (OFDMA) scheme is taken as an example in the following description, and the present invention can be similarly applied to communication systems using other multiple access schemes.

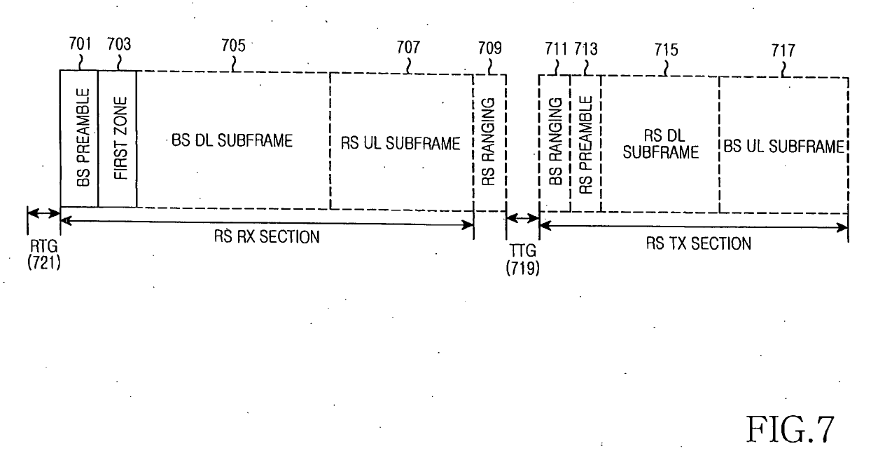

FIG. 7 is a diagram illustrating a frame structure for a TDM-based multi-hop relay cellular network according to the present invention.

Referring to FIG. 7, the frame is divided into an RX section for an RS (hereinafter RS RX section) and a TX section for the RS.

The RS RX section includes a DL subframe for a direct link (hereinafter direct DL subframe) and a UL subframe for a relay link (hereinafter relay UL subframe).

The direct DL subframe includes a BS preamble 701, a first zone 703 containing UL/DL burst allocation information, and a BS DL subframe 705 containing DL data transmitted from a BS to an RS and an MS_{BS}.

The relay UL subframe includes an RS UL subframe 707 and an RS ranging field 709. The RS UL subframe 707 contains UL data transmitted from an MS_{RS} to the RS, and the RS ranging field 709 is used to allocate a resource from the RS to the MS_{RS}.

The RS ranging field 709 is located at the end of the relay UL subframe.

The RS TX section includes a relay DL subframe and a direct UL subframe.

The relay DL subframe includes a BS ranging field 711, an RS preamble 713, and an RS DL subframe 715. The BS ranging field 711 is used to allocate resources from the BS to the RS and the MS_{BS}, and the RS DL subframe 715 contains DL data transmitted from the RS to the MS_{RS}.

The direct UL subframe includes a BS UL subframe 717 that contains UL data transmitted from the RS and the MS_{BS} to the BS.

Accordingly, the RS preamble 713 has a fixed position.

The RS performs a synchronized operation and the respective subframes are multiplexed in a TDM scheme. Therefore, burst allocation in each link can be performed independently for the direct link and the relay link.

In addition, because the frame is divided into the RS RX section and the RS TX section, an RS switching operation is performed in a TTG 719, but not in each section.

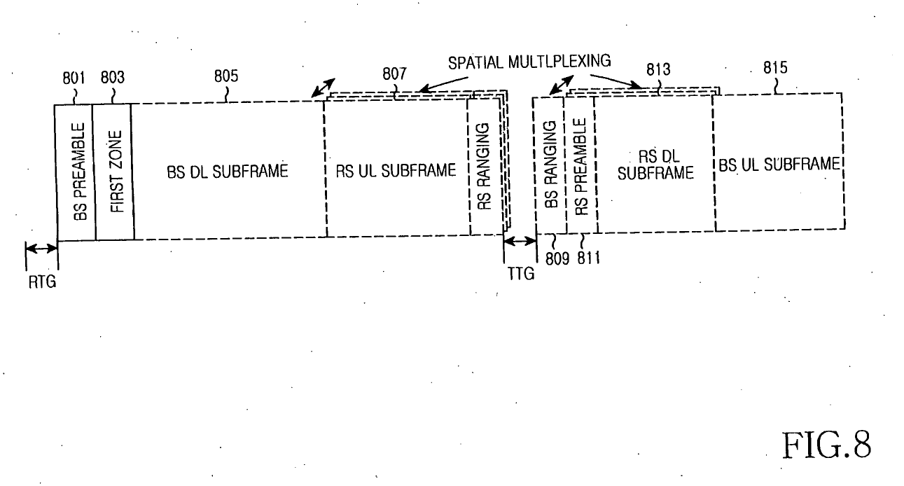

FIG. 8 is a diagram illustrating the structure of a frame for constructing a spatial multiplexing RS link in a TDM-based multi-hop relay cellular network according to the present invention. In the following description, it is assumed that subframes are multiplexed in a TDM scheme.

The frame structure of FIG. 8 is designed to increase a data rate in an RS link by applying, when a plurality of RSs exist in one cell, a spatial multiplexing scheme to the RSs that are spaced apart from each other.

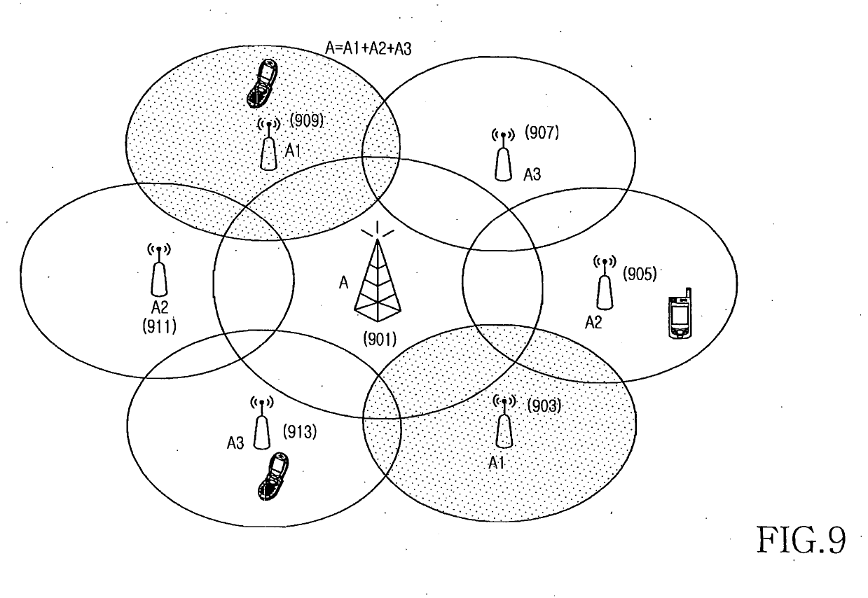

Unlike the frame structure of FIG. 7, the frame structure of FIG. 8 has as many RS UL subframes 807, RS ranging fields 809, RS preambles 811 and RS DL subframes 813 as the number of resources that are used by the RSs. Accordingly, it is possible to reuse frequency resources as illustrated in FIG. 9.

FIG. 9 is a diagram of a spatial multiplexing multi-hop relay cellular network according to the present invention. Referring to FIG. 9, a BS 901 includes a first RS 903, a second RS 905, a third RS 907, a fourth RS 909, a fifth RS 911 and a sixth RS 913.

When the BS 901 uses a resource A that is the sum of subresources A1, A2 and A3, the RSs that are spaced apart from each other by a large distance use the same subresource. For example, RSs 903 and 909 use subresource A1, RSs 905 and 911 use subresource A2, and RSs 907 and 913 use subresource A3. That is, it is possible to reuse the same subresource between the RSs that are spaced apart from each other by a large distance. The subresource may be a two-dimensional type of Time×Frequency.

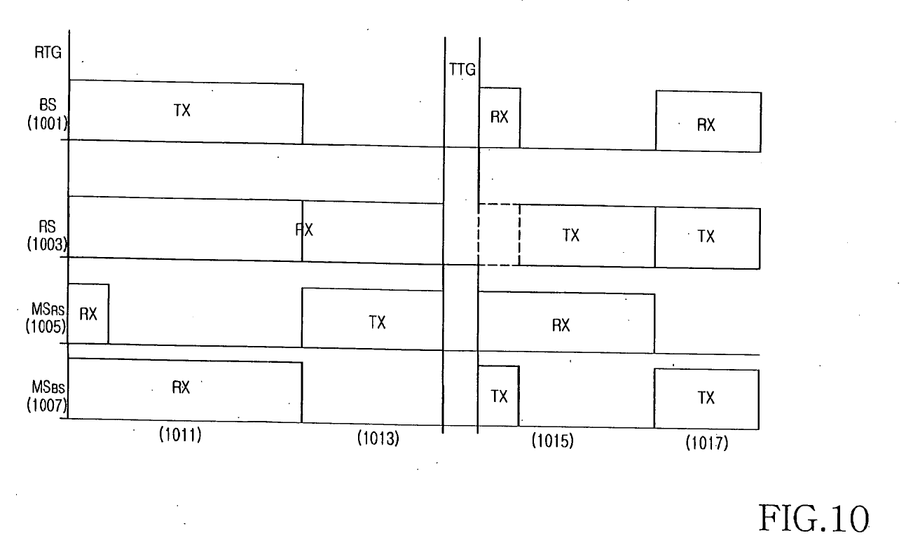

FIG. 10 is a diagram illustrating a procedure for transmitting signals in a TDM-based multi-hop relay cellular network according to the present invention. Referring to FIG. 10, when a BS 1001 transmits a DL frame, an RS 1003 and an MS_{BS} 1007 receive the DL frame of the BS 1001 (Section 1011). At this point, an MS_{RS} 1005 may receive a preamble signal of the BS 1001.

When the MS_{RS} 1005 transmits a UL frame, the RS 1003 receives the UL frame from the MS_{RS} 1005 (Section 1013). Thereafter, a guard region TTG follows. When the RS 1003 transmits a signal received from the BS 1001 to the MS_{RS} 1005, the MS_{RS} 1005 receives a DL frame of the RS 1003 (Section 1015). At this point, the MS_{RS} 1005 receives a preamble signal transmitted from the RS 1003, and the BS 1001 receives a ranging signal transmitted from the RS 1003 and the MS_{BS} 1007.

When the RS 1003 transmits a UL frame received from the MS_{RS} 1005 to the BS 1001 and the MS_{BS} 1007 also transmits a UL signal, the BS 1001 receives a TX signal of the MS_{BS} 1007 (Section 1017).

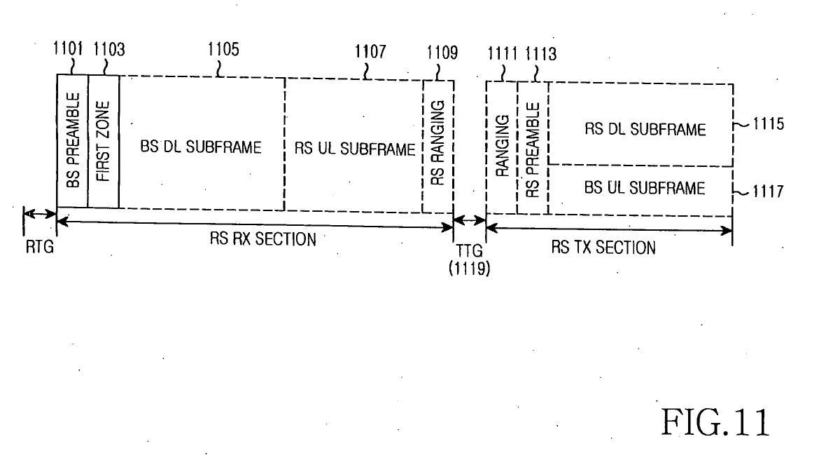

FIG. 11 is a diagram illustrating the structure of a frame for a hybrid multiplexing scheme based multi-hop relay cellular network according to the present invention. Referring to FIG. 11, the frame is divided into an RS RX section and an RS TX section. In the hybrid multiplexing scheme, the RS RX section multiplexes subframes of different links in a TDM scheme and the RS TX section multiplexes subframes of different links in an FDM scheme.

The RS RX section includes a direct DL subframe and a relay UL subframe that are multiplexed in a TDM scheme in the same manner as the RS RX section of FIG. 7. In the RS TX section, an RS DL subframe 1115 and a BS UL subframe 1117 are multiplexed in an FDM scheme. Because a plurality of RSs and MSs may perform transmission in the RS DL subframe 1115 and the BS UL subframe 1117, there is required a burst allocation scheme that can provide a symbol structure containing a pilot in all subframes. Accordingly, each link can be multiplexed in an FDM scheme. Allocation of FDM bursts enables a gain due to a narrow band operation.

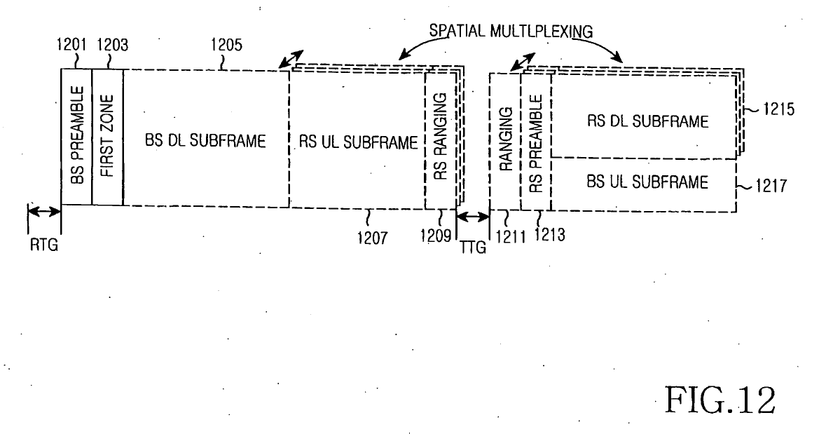

FIG. 12 is a diagram illustrating the structure of a frame for constructing a spatial multiplexing RS link in a hybrid multiplexing scheme based multi-hop relay cellular network according to the present invention. The frame structure of FIG. 12 is designed to increase a data rate in an RS link by applying, when a plurality of RSs exist in one cell, a spatial multiplexing scheme to the RSs that are spaced apart from each other.

Unlike the frame structure of FIG. 11, the frame structure of FIG. 12 has as many RS UL subframes 1207, RS ranging fields 1209, RS preambles 1213 and RS DL subframes 1215 as the number of resources that are used by the RSs. Accordingly, it is possible to reuse frequency resources between the RSs that are spaced apart from each other by a long distance. A subresource may be a two-dimensional type of Time×Frequency.

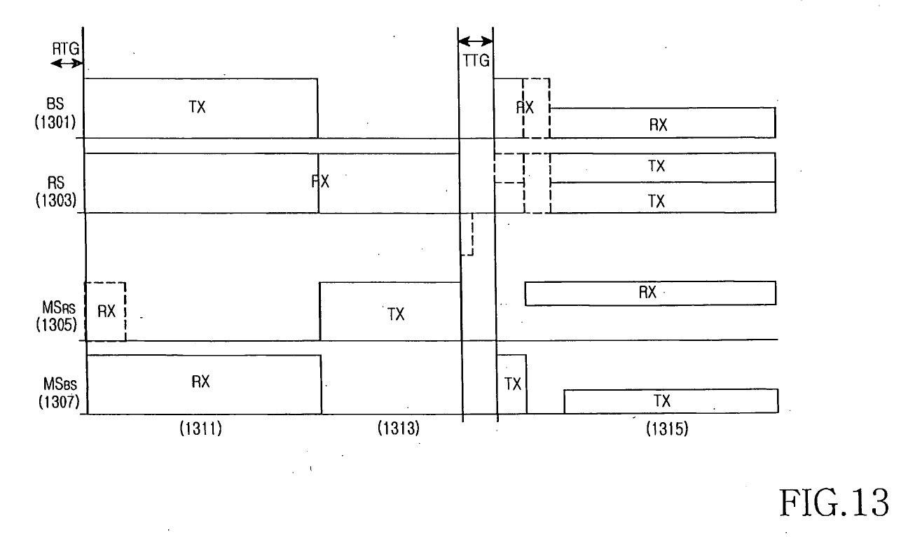

FIG. 13 is a diagram illustrating a procedure for transmitting/receiving signals in a hybrid multiplexing scheme based multi-hop relay cellular network according to the present invention.

Referring to FIG. 13, when a BS 1301 transmits a DL frame, an RS 1303 and an MS_{BS} 1307 receive the DL frame of the BS 1301 (Section 1311). At this point, an MS_{RS} 1305 may receive a preamble signal of the BS 1301.

When the MS_{RS} 1305 transmits a UL frame, the RS 1303 receives the UL frame from the MS_{RS} 1305 (Section 1313).

Thereafter, a guard region TTG follows. Using an FDM scheme, the RS 1303 transmits a signal received from the BS 1301 to the MS_{RS} 1305, and the RS 1303 and the MS_{BS} 1307 transmit UL signals to the BS 1301 (Section 1315). At this point, the MS_{RS} 1305 receives a DL burst of the RS 1303 and the BS 1301 receives UL signals from the RS 1303 and the MS_{BS} 1307.

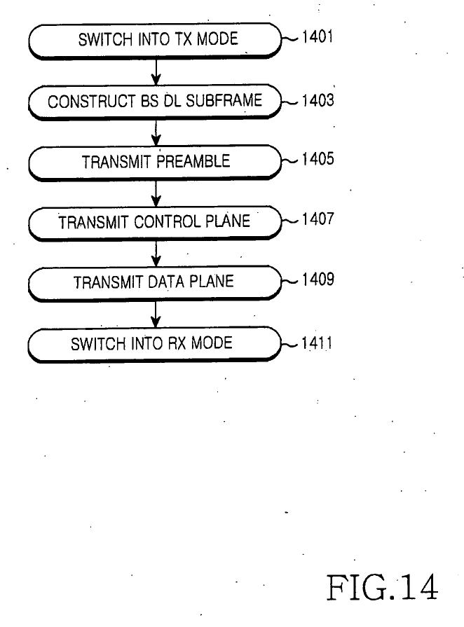

FIG. 14 is a flow diagram illustrating a procedure for transmitting signals from a BS according to the present invention. Referring to FIG. 14, the BS switches into a TX mode in step 1401. In step 1403, the BS constructs a DL subframe using the preamble, control information and data of the BS. The control information includes UL/DL burst allocation information. In steps 1405, 1407 and 1409, the BS transmits the DL subframe to an MS_{BS} and an RS. That is, the BS transmits the preamble, the control information and the data in steps 1405, 1407 and 1409, respectively. Thereafter, the BS switches into an RX mode in step 1411.

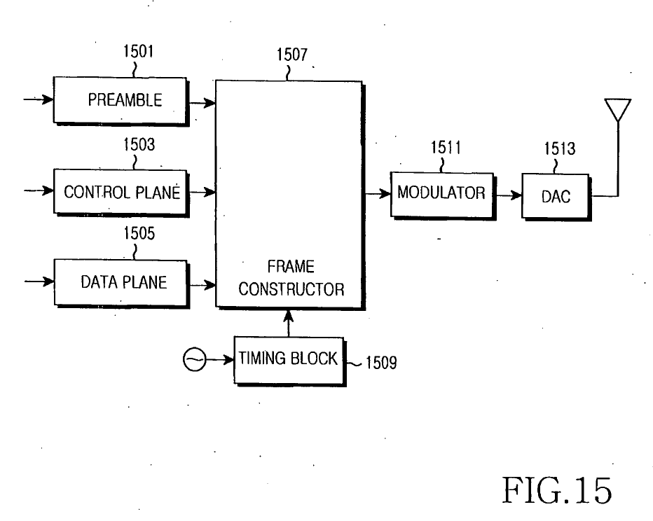

FIG. 15 is a block diagram of a transmitter of a BS according to the present invention. Referring to FIG. 15, the BS transmitter includes an antenna, a preamble channel 1501, a control plane channel 1503, a data plane channel 1505, a frame constructor 1507, a timing controller 1509, a modulator 1511 and a Digital-to-Analog Converter (DAC) 1513.

A preamble, TX data and control information including data allocation information are outputted from an upper layer to the frame constructor 1507 through the preamble channel 1501, the control plane channel 1503 and the data plane channel 1505, respectively.

Using the preamble, the control information and the TX data, the frame constructor 1507 constructs a BS DL subframe and outputs the BS DL subframe to the modulator 1511. At this point, the frame constructor 1507 receives a timing signal from the timing controller 1509 to construct the BS DL subframe. The timing signal is used to determine a time point where the BS DL subframe is transmitted in one frame.

The modulator 1511 modulates the BS DL subframe into a digital signal by a modulation scheme and outputs the resulting digital signal to the DAC 1513. The DAC 1513 converts the digital signal into an analog signal which it transmits through the antenna.

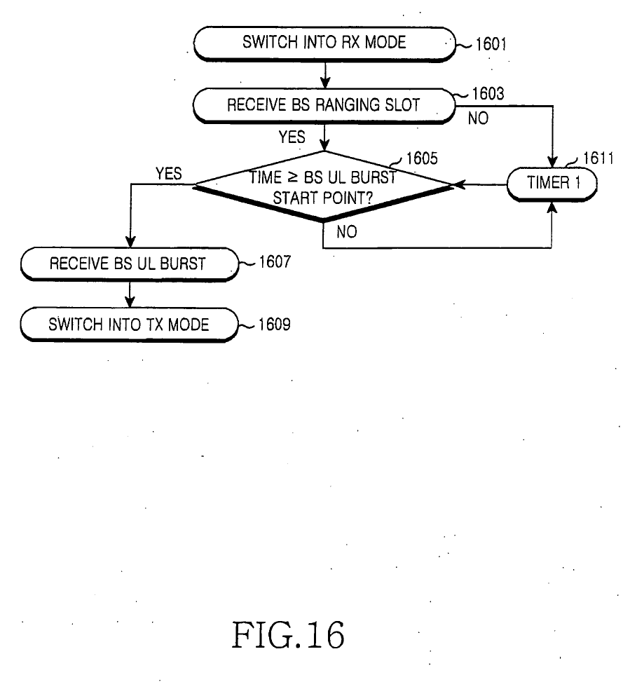

FIG. 16 is a flow diagram illustrating a procedure for receiving signals at a BS according to the present invention. Referring to FIG. 16, the BS determines in step 1601 whether to switch into an RX mode. If it switches into an RX mode, the procedure proceeds to step 1603.

In step 1603, the BS determines whether the ranging signal of FIG. 7 is received from an RS and an MS_{BS}. If so, the procedure proceeds to step 1605, and if not, the procedure proceeds to step 1611.

In step 1605 the BS compares a time point of a timer 1 with a start point of a BS UL burst that is received from the RS and the MS_{BS}. If the time point of the timer 1 is greater than or equal to the start point of the BS UL burst, the procedure proceeds to step 1607, and if not, the procedure proceeds to step 1611.

In step 1607, the BS receives the BS UL burst. Thereafter, the BS switches into a TX mode in step 1609. In step 1611, the BS waits until the time point of the timer 1 reaches the start point of the BS UL burst.

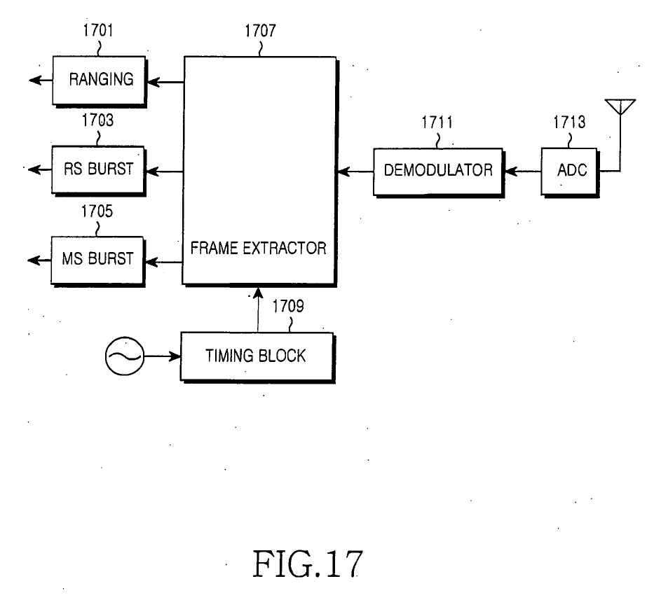

FIG. 17 is a block diagram of a receiver of a BS according to the present invention. Referring to FIG. 17, the BS receiver includes an antenna, an analog-to-digital converter (ADC) 1713, a demodulator 1711, a frame extractor 1707, a timing controller 1709, a ranging channel 1701, an RS burst channel 1703 and an MS burst channel 1705.

The ADC 1713 converts an analog signal received through the antenna into a digital signal. The demodulator 1711 demodulates the digital signal by a demodulation scheme.

In synchronization with a timing signal received from the timing controller 1709, the frame extractor 1707 splits the output signal of the demodulator 1711 into a ranging signal, an RS burst and an MS burst and outputs the ranging signal, the RS burst and the MS burst to their respective channels 1701, 1703 and 1705.

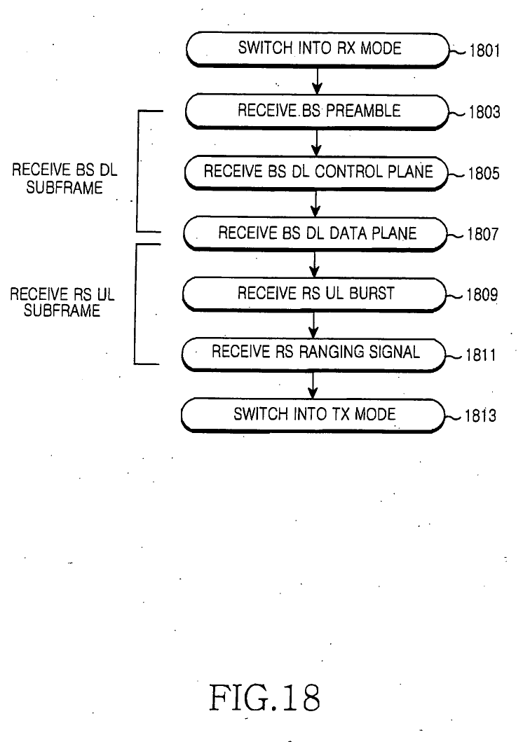

FIG. 18 is a flow diagram illustrating a procedure for receiving signals at an RS according to the present invention. Referring to FIG. 18, the RS determines in step 1801 whether to switch into an RX mode. If it switches into an RX mode, the procedure proceeds to step 1803.

In steps 1803, 1805 and 1807, the RS receives a BS DL subframe from a BS. That is, the RS receives the preamble, control information and data of the BS DL subframe from the BS in steps 1803, 1805 and 1807, respectively. In steps 1809 and 1811, the RS determines whether an RS UL subframe is received from an MS_{RS}. That is, the RS receives an RS UL burst and an RS ranging signal from the MS_{RS} in steps 1809 and 1811, respectively. The MS then switches into a TX mode in step 1813.

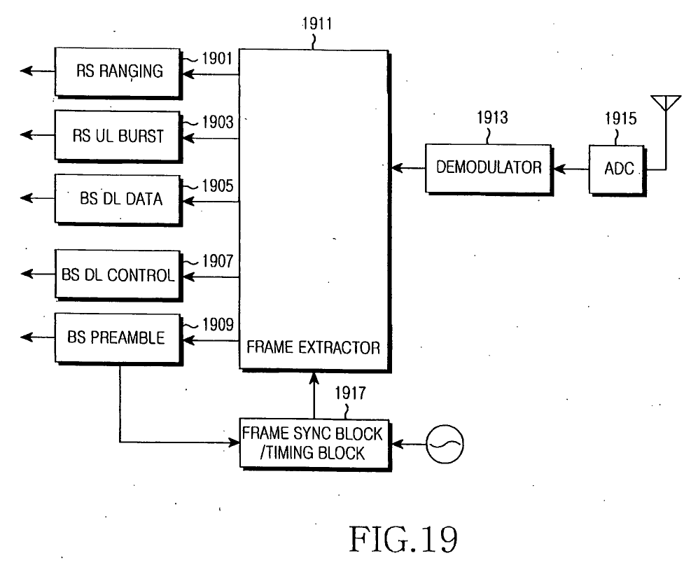

FIG. 19 is a block diagram of a receiver of an RS according to the present invention. Referring to FIG. 19, the RS receiver includes an antenna, an ADC 1915, a demodulator 1913, a frame extractor 1911, a timing controller 1917, a ranging channel 1901, an RS UL burst channel 1903, a BS DL data channel 1905, a BS DL control channel 1907 and a BS preamble 1909. The timing controller 1917 includes a frame sync block and a timing block.

The ADC 1915 converts an analog signal received through the antenna into a digital signal. The demodulator 1913 demodulates the digital signal by a demodulation scheme.

When a frame provided from the demodulator 1913 is, an RS UL frame received from an MS_{RS}, the frame extractor 1911 splits the output signal of the demodulator 1913 into an RS ranging signal and an RS UL burst. On the other hand, when the frame is a BS DL frame received from a BS, the frame extractor 1911 splits the output signal of the demodulator 1913 into BS DL data, BS DL control information and a BS preamble.

At this point, the frame extractor 1911 synchronizes with the BS using a sync signal and timing information that are received from the timing controller 1917. In addition, the frame extractor 1911 splits two subframes received in synchronization with the timing information provided from the timing controller 1917. Although not illustrated in FIG. 19, the sync signal is obtained from the BS preamble 1909 and is provided to the frame sync block of the timing controller 1917.

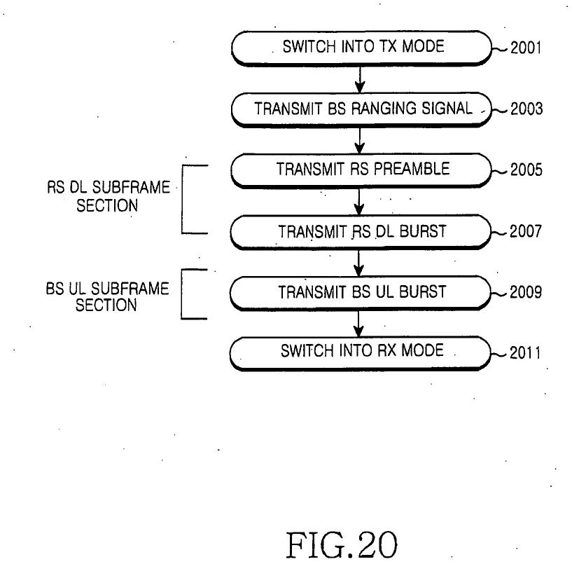

FIG. 20 is a flow diagram illustrating a procedure for transmitting signals from an RS using a TDM frame structure according to the present invention. Referring to FIG. 20, the RS switches into a TX mode in step 2001. In step 2003, the RS transmits a BS ranging signal to a BS. The BS ranging signal is used to allocate a resource for transmitting a signal from the BS.

In steps 2005 and 2007, the RS transmits a preamble and the RS DL subframe to the MS_{RS} so that the MS_{RS} can synchronize with the RS. That is, an RS preamble and an RS DL burst are transmitted to the MS_{RS} in steps 2005 and 2007, respectively. At this point, the received control information as well as the received BS DL data may be transmitted. In step 2009, the RS transmits a BS UL burst to the BS. The BS UL burst includes the control information and UL data of the MS_{RS}. Thereafter, the RS switches into an RX mode in step 2011.

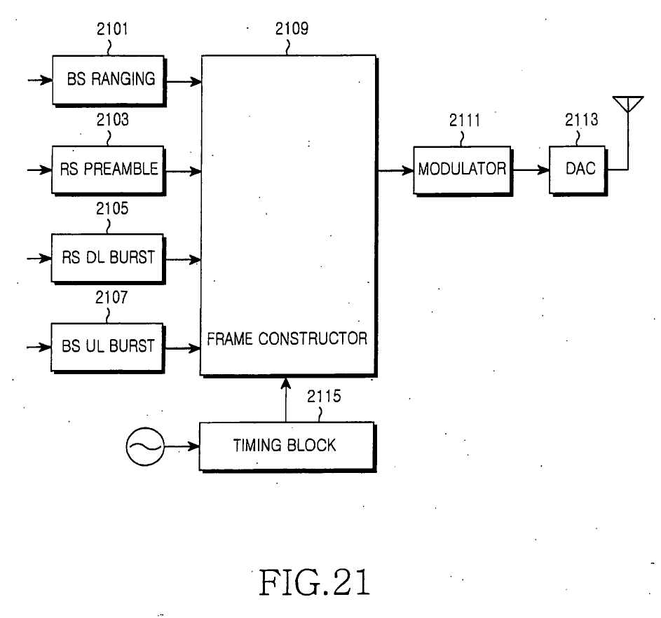

FIG. 21 is a block diagram of a transmitter of an RS using a TDM frame structure according to the present invention. Referring to FIG. 21, the RS transmitter includes an antenna, a BS ranging channel 2101, an RS preamble channel 2103, an RS DL burst channel 2105, a BS UL burst channel 2107, a frame constructor 2109, a timing controller 2115, a modulator 2111 and a DAC 2113.

In order to transmit data from the RS to a BS, a BS ranging signal, an RS preamble, an RS DL burst and a BS UL burst are outputted to the frame constructor 2109 through their respective channels 2101, 2103, 2105 and 2107.

Using the BS ranging signal, the RS preamble, the RS DL burst and the BS UL burst, the frame constructor 2109 constructs an RS DL subframe and a BS UL subframe and outputs them to the modulator 2111. The frame constructor 2109 receives a timing signal from the timing controller 2115 to construct and output the RS DL subframe and the BS UL subframe. The timing signal is used to determine a time point where the RS DL burst and the BS UL burst are transmitted from the RS in one frame.

The modulator 2111 modulates the RS DL subframe and the BS UL burst into digital signals by a modulation scheme and outputs the resulting digital signals to the DAC 2113. The DAC 2113 converts the digital signals into analog signals and transmits the resulting analog signals through the antenna.

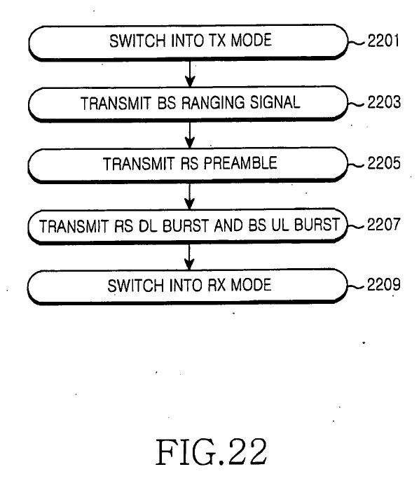

FIG. 22 is a flow diagram illustrating a procedure for transmitting signals from an RS using an FDM frame structure according to the present invention. Referring to FIG. 22, the RS switches into a TX mode in step 2201. In step 2203, the RS transmits a BS ranging signal to a BS. The BS ranging signal is used to allocate a resource for transmitting a signal from the BS.

In step 2205, the RS transmits an RS preamble. In step 2207, using an FDM scheme, the RS transmits an RS DL burst and a BS UL burst to the MS_{RS} and the BS, respectively. Thereafter, the RS switches into an RX mode in step 2209.

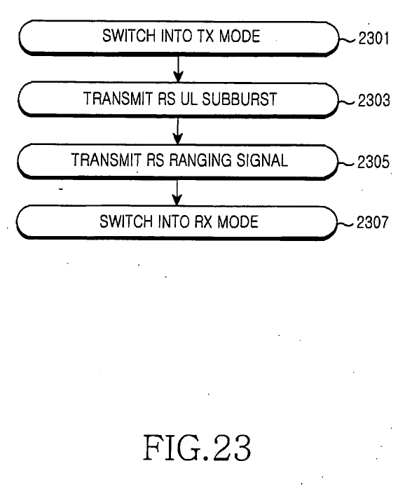

FIG. 23 is a flow diagram illustrating a procedure for transmitting signals from an MS_{RS} to an RS according to the present invention. Referring to FIG. 23, the MS_{RS} switches into a TX mode in step 2301. In step 2303, the MS_{RS} transmits an RS UL subburst to the RS. In step 2305, the MS_{RS} transmits an RS ranging signal to the RS and switches into an RX mode in step 2307.

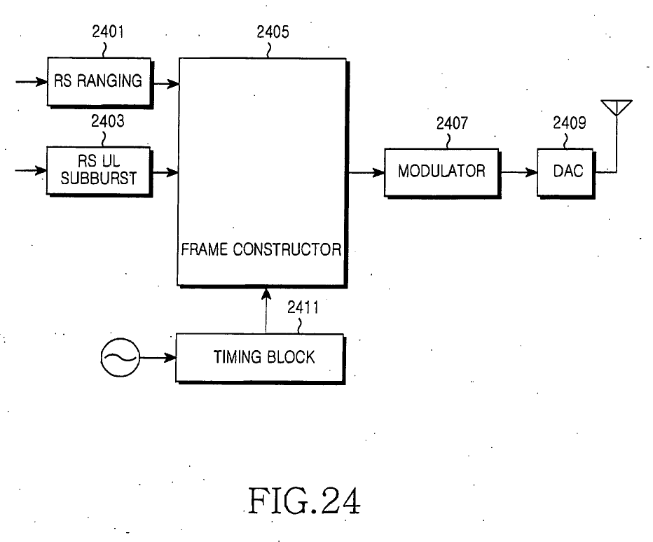

FIG. 24 is a block diagram of a MS_{RS} transmitter for transmitting signals to an RS according to the present invention. Referring to FIG. 24, the MS_{RS} transmitter includes an antenna, an RS ranging channel 2401, an RS UL subburst channel 2403, a frame constructor 2405, a timing controller 2411, a modulator 2407 and a DAC 2409.

In order to transmit data to the RS, the MS_{RS} outputs an RS ranging signal and an RS UL burst to the frame constructor 2405 through the RS ranging channel 2401 and the RS UL burst channel 2403, respectively.

In synchronization with a timing signal received from the timing controller 2411, the frame constructor 2405 constructs an RS UL subframe using the RS ranging signal and the RS UL burst.

The modulator 2407 modulates the RS UL subframe into a digital signal by a modulation scheme. The DAC 2409 converts the digital signal into an analog signal which it transmits through the antenna.

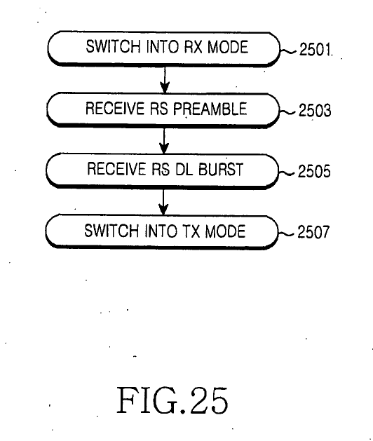

FIG. 25 is a flow diagram illustrating a procedure for receiving signals at an MS_{RS} from an RS according to the present invention. Referring to FIG. 25, the MS_{RS} switches into an RX mode in step 2501. In step 2503, the MS_{RS} receives an RS preamble from the RS. In step 2505, the MS_{RS} receives an RS DL burst from the RS. The MS_{RS} switches into a TX mode in step 2507.

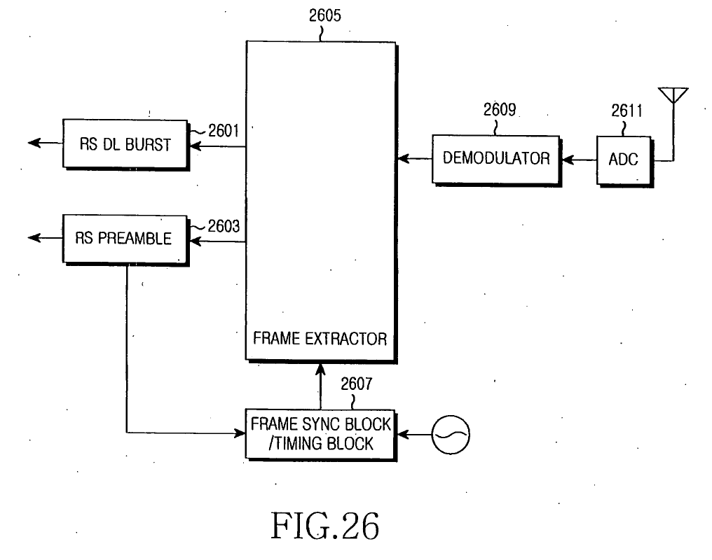

FIG. 26 is a block diagram of an MS_{RS} receiver for receiving signals from an RS according to the present invention. Referring to FIG. 26, the MS_{RS} receiver includes an antenna, an RS DL burst channel 2601, an RS preamble channel 2603, a frame extractor 2605, a timing controller 2607, a demodulator 2609 and an ADC 2611. The timing controller 2607 includes a frame sync block and a timing block.

The ADC 2611 converts an analog signal received through the antenna into a digital signal. The demodulator 2609 demodulates the digital signal by a demodulation scheme.

The frame extractor 2605 splits an output frame of the demodulator 2609 into an RS DL burst and an RS preamble. The frame extractor 2605 synchronizes with the RS using a sync signal and timing information that are received from the timing controller 2607. When a start point of the frame is less than the timing information from the timing controller 2607, the received frame is split and outputted. Although not illustrated in FIG. 26, the sync signal is obtained from the RS preamble channel 2603 and is provided to the frame sync block of the timing controller 2607.

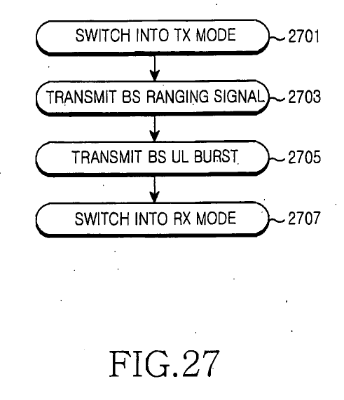

FIG. 27 is a flow diagram illustrating a procedure for transmitting signals from an MS to a BS according to the present invention. Referring to FIG. 27, the MS_{BS} switches into a TX mode in step 2701. In step 2703, the MS_{BS} transmits a BS ranging signal to the BS. In step 2705, the MS_{BS} transmits a BS UL burst to the BS. The MS_{BS} switches into an RX mode in step 2707.

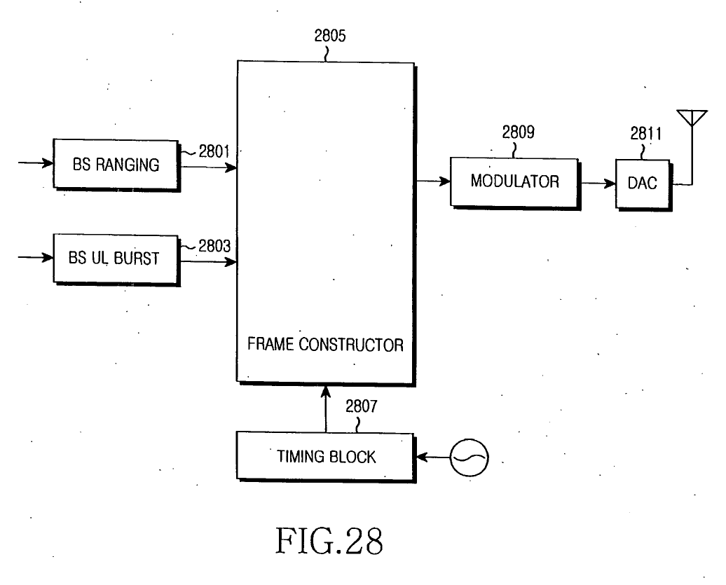

FIG. 28 is a block diagram of an MS_{BS} transmitter for transmitting signals to a BS according to the present invention. Referring to FIG. 28, the MS_{BS} transmitter includes an antenna, a BS ranging channel 2801, a BS UL burst channel 2803, a frame constructor 2805, a timing controller 2807, a modulator 2809 and a DAC 2811.

In order to transmit data to the BS, the MS_{BS} outputs a BS ranging signal and a BS UL burst to the frame constructor 2805 through the BS ranging channel 2801 and the BS UL burst channel 2803, respectively.

In synchronization with a timing signal received from the timing controller 2807, the frame constructor 2805 constructs a BS UL subframe using the BS ranging signal and the BS UL burst.

The modulator 2809 modulates the BS UL subframe into a digital signal by a modulation scheme. The DAC 2811 converts the digital signal into an analog signal which it transmits through the antenna.

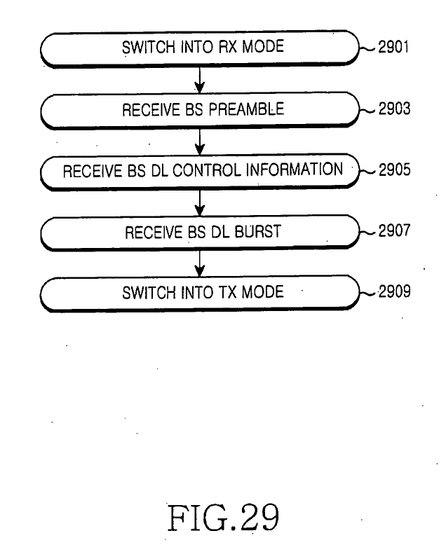

FIG. 29 is a flow diagram illustrating a procedure for receiving signals at an MS_{BS} from a BS according to the present invention. Referring to FIG. 29, the MS_{BS} switches into an RX mode in step 2901. In step 2903, the MS_{BS} receives a BS preamble from the BS. In steps 2905 and 2907, the MS_{BS} sequentially receives BS DL control information and a BS DL burst from the BS. The MS_{BS} switches into a TX mode in step 2909.

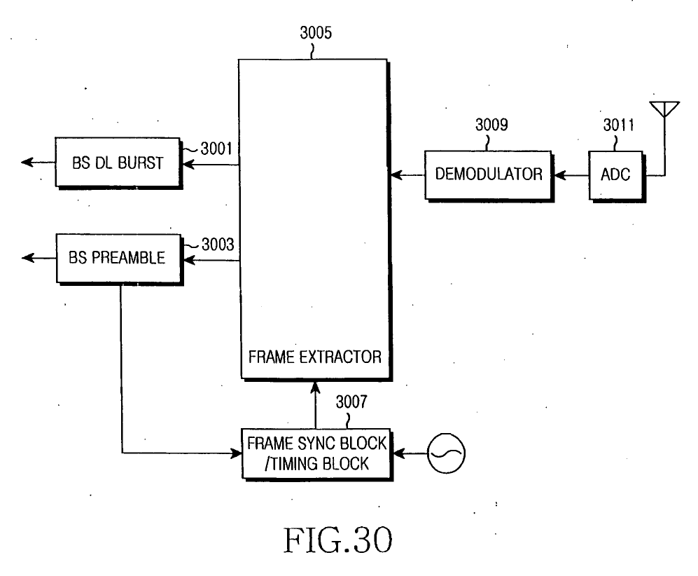

FIG. 30 is a block diagram of an MS_{BS} receiver for receiving signals from a BS according to the present invention. Referring to FIG. 30, the MS_{BS} receiver includes an antenna, a BS DL burst channel 3001, a BS preamble channel 3003, a frame extractor 3005, a timing controller 3007, a demodulator 3009 and an ADC 3011. The timing controller 3007 includes a frame sync block and a timing block.

The ADC 3011 converts an analog signal received through the antenna into a digital signal. The demodulator 3009 demodulates the digital signal by a demodulation scheme.

The frame extractor 3005 splits the output frame of the demodulator 3009 into a BS DL burst and a BS preamble. The frame extractor 3005 synchronizes with the BS using a sync signal and timing information that are received from the timing controller 3007. When a start point of the frame is less than the timing information received from the timing controller 3007, the received frame is split and outputted. Although not illustrated in FIG. 30, the sync signal is obtained from the BS preamble channel 3003 and is provided to the frame sync block of the timing controller 3007.

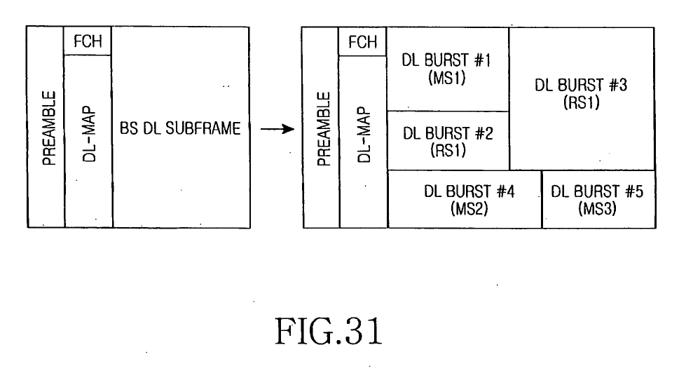

FIGS. 31 through 36 illustrate a detailed structure of each subframe constituting the frame. In FIGS. 31 through 36, a dotted line indicates that a burst size may substantially vary.

FIG. 31 is a diagram illustrating the structure of a BS DL subframe according to the present invention. Referring to FIG. 31, the BS DL subframe is allocated a two-dimensional OFDM burst for transmitting data to an RS and an MS having a direct link with the BS.

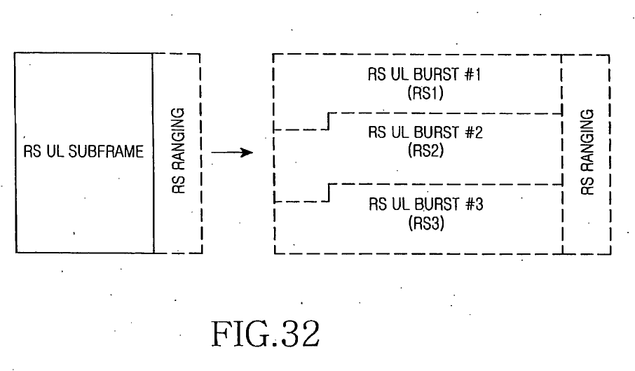

FIG. 32 is a diagram illustrating the structure of an RS UL subframe according to the present invention. Referring to FIG. 32, the RS UL subframe includes bursts for a plurality of RSs and an OFDMA slot is allocated to each of the bursts on a time priority basis.

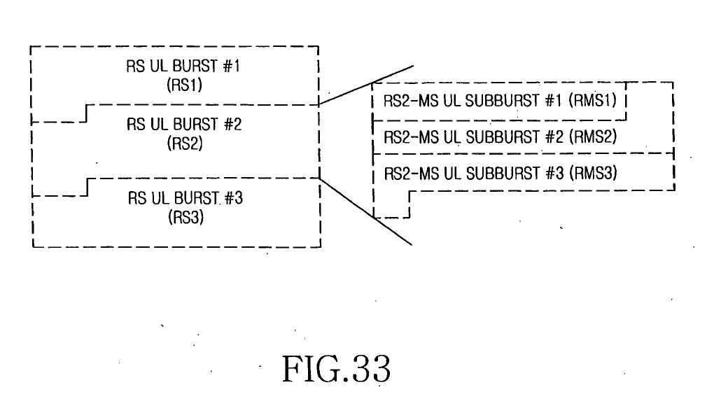

FIG. 33 is a diagram illustrating the structure of a burst of the RS UL subframe according to the present invention. Referring to FIG. 33, the RS UL burst includes subbursts for supporting MSs having respective RS links in each RS illustrated in FIG. 32, and an OFDMA slot is allocated to each of the subbursts on a time priority basis.

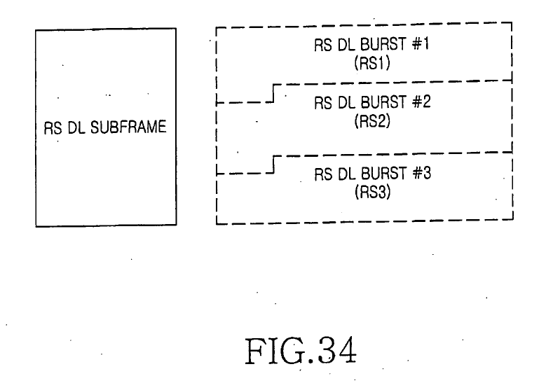

FIG. 34 is a diagram illustrating the structure of an RS DL subframe according to the present invention. Referring to FIG. 34, the RS DL subframe includes bursts that RSs use to transmit data through their own links, and an OFDMA burst is allocated to each of the bursts on a time priority basis.

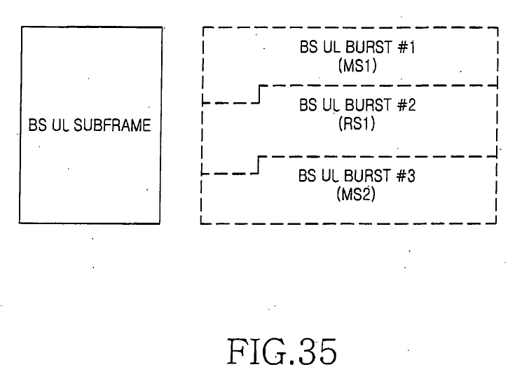

FIG. 35 is a diagram illustrating the structure of a BS UL subframe according to the present invention. Referring to FIG. 35, the BS UL subframe includes bursts that MSs and RSs use to transmit UL data, and an OFDMA slot is allocated to each of the bursts on a time priority basis.

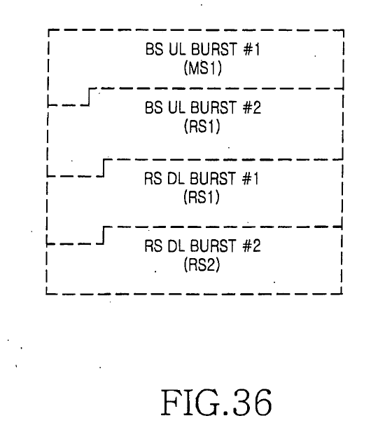

FIG. 36 is a diagram illustrating the structure of a hybrid UL subframe according to the present invention. Referring to FIG. 36, the hybrid UL subframe includes BS UL subframes and RS DL subframes that are FDM-multiplexed and include a corresponding burst, and an OFDM slot is allocated to each burst on a time priority basis.

As described above, an OFDMA slot is allocated to each burst on a time priority basis, which enables the realization of a narrowband gain.

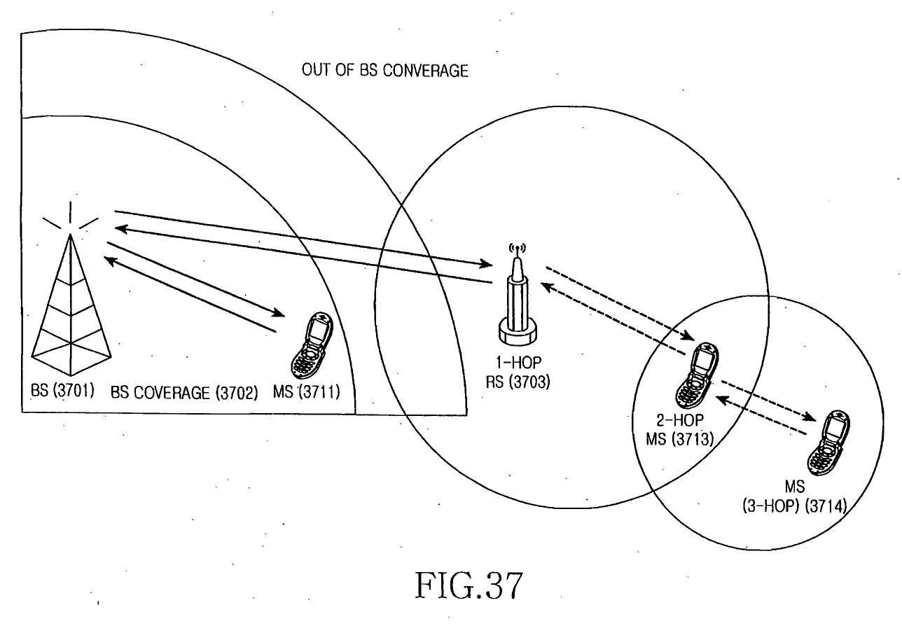

FIG. 37 is a diagram of a 3-hop relay cellular network according to the present invention. Referring to FIG. 37, an MS 3711, which is located inside a coverage area 3702 of a BS 3701, communicates directly with the BS 3701. An RS 3703 is used to expand the coverage area 3702. That is, the RS 3703 relays communication between the BS 3701 and an MS 3713 that is located outside the coverage area 3702, so that the MS 3713 can communicate with the BS 3701. Likewise, the MS 3713 relays communication between the BS 3701 and another MS 3714 so that the MS 3714 can communication with the BS 3701.

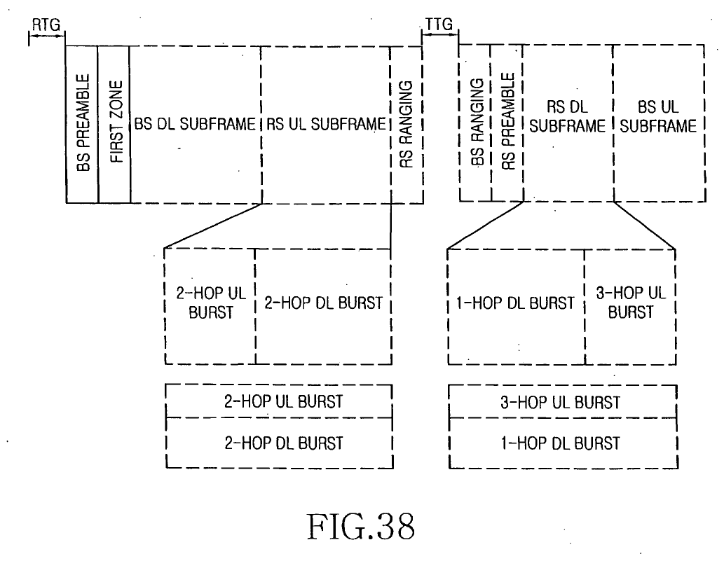

FIG. 38 is a diagram illustrating a frame structure capable of supporting a multi-hop structure illustrated in FIG. 37 according to the present invention. Referring to FIG. 38, an RS UL subframe is a 2-hop RS TX section corresponding to a section for transmission from a 2-hop RS to a 1-hop RS in FIG. 7. The multi-hop architecture can be divided into an RS UL subframe section and an RS DL subframe section. The RS UL subframe section is used for transmission from a 2-hop RS and includes a 2-hop UL burst section and a 2-hop DL burst section. The RS DL subframe section is used for reception at the 2-hop RS and includes a 1-hop DL burst section and a 3-hop UL burst section. The respective sections are used for transmission from a plurality of RSs and thus can be multiplexed on an FDM and a TDM basis. In addition, because an RS hop switch operation does not occur in each section, a transmission gap due to RS switching is unnecessary.

As described above, the direct link and the relay link are constructed in one frame in the multi-hop cellular network, and the frame is constructed to include the RS TX and RX sections. The BS DL subframe and the RS UL subframe are located in the conventional DL subframe. Accordingly, it is possible to eliminate an overhead for the RS receive transition gap (RTG) in the DL subframe and an overhead for the RS transmit transition gap (TTG) in the conventional UL subframe. In addition, the start points of the BS DL subframe and the RS DL subframe are fixed using the preamble while the subframe length is dynamically adjusted according to each link load. Accordingly, it is possible to simultaneously solve difficulties in performing initial sync for the MS, handoff, and cell search. Also, it is possible to allocate bursts for a plurality of transmitting ends in each subframe. Moreover, in the downlink, the direct link and the multi-link are multiplexed on a TDM basis, so that the BS and the RS can have independent burst structures.

While the present invention has been shown and described with reference to certain preferred embodiments thereof, it will be understood by those skilled in the art that various changes in form and details may be made therein without departing from the spirit and scope of the present invention as defined by the appended claims.

What is claimed is:

1. A relay station (RS) transmitter in a multi-hop relay cellular network, the RS transmitter comprising:
a frame constructor for constructing frames to be transmitted to a mobile station (MS) and a base station (BS) by sequentially positioning a ranging signal, a preamble and downlink (DL) bursts to be transmitted to the MS, and uplink (UL) bursts to be transmitted to the BS; and
a timing controller for providing a timing signal indicating the time to transmit the constructed frames to the MS and the BS.

2. The RS transmitter of claim 1, wherein the frame constructor constructs a BS ranging signal using the ranging signal, constructs a DL subframe using the preamble and the DL burst to be transmitted to the MS, and constructs a UL subframe using the UL burst to be transmitted to the BS.

3. The RS transmitter of claim 2, wherein the BS ranging signal, the DL subframe and the UL subframe are sequentially transmitted under the control of the timing controller.

4. A relay station (RS) receiver in a multi-hop relay cellular network, the RS receiver comprising:
a frame extractor for extracting a base station (BS) preamble, base station downlink (BS DL) control information, BS DL data from a DL subframe received from the BS and an RS uplink (UL) burst and an RS ranging signal a UL subframe received from a mobile station (MS); and
a timing controller for providing a timing signal for determining whether the DL subframe and the UL subframe are received through a direct link or through a relay rink.

5. The RS receiver of claim 4, wherein the UL subframe includes the RS UL burst and the RS ranging signal.

6. The RS receiver of claim 4, wherein the DL subframe includes the BS preamble, the BS DL control information and the BS DL data.

7. The RS receiver of claim 4, wherein the BS preamble, the BS DL control information, the BS DL data, the RS UL burst and the RS ranging signal are sequentially received at the frame extractor.

8. A base station (BS) transmitter in a multi-hop relay cellular network, the BS transmitter comprising:
a frame constructor for constructing a downlink (DL) frame to be transmitted to a mobile station (MS) and a relay station (RS) by using a preamble signal, control information and a DL burst; and
a timing controller for providing a timing signal indicating the time to transmit the constructed DL frame.

9. The BS transmitter of claim 8, wherein the frame constructor sequentially constructs the DL frame using the preamble signal, the control information and the DL burst.

10. A base station (BS) receiver in a multi-hop relay cellular network, the BS receiver comprising:
a frame extractor for receiving uplink (UL) frames from a relay station (RS) and a mobile station (MS) and splitting the received uplink (UL) frames into a ranging signal, a UL burst transmitted from the RS and a UL burst transmitted from the MS; and
a timing controller for providing a timing signal for determining whether to receive the UL frames.

11. The BS receiver of claim 10, wherein the ranging signal and the UL burst are sequentially received at the frame extractor.

12. The BS receiver of claim 11, wherein the UL burst includes the UL burst transmitted from the RS and the UL burst transmitted from the MS.

13. A method for receiving signals at a relay station (RS) in a multi-hop relay cellular network, the method comprising the steps of:
determining whether a downlink (DL) subframe is received from a base station (BS);
if the DL subframe is received, determining whether an uplink (UL) subframe is received from a mobile station (MS); and
if the UL subframe is received, switching into a transmission (TX) mode.

14. The method of claim 13, wherein the DL subframe includes a BS preamble, BS DL control information, and a BS DL burst.

15. The method of claim 14, wherein the BS preamble, the BS DL control information, and the BS DL burst are received sequentially.

16. The method of claim 13, wherein the DL subframe is allocated a two-dimensional burst for transmitting data to the MS and the RS.

17. The method of claim 13, wherein the UL subframe includes a UL burst and a ranging signal that are transmitted from the MS.

18. The method of claim 17, wherein the UL burst and the ranging signal are received sequentially.

19. The method of claim 13, wherein the UL subframe includes bursts for a plurality of RSs and a slot is allocated to each of the bursts on a time priority basis.

20. A method for transmitting signals from a relay station (RS) in a time-division multiplexing (TDM) multi-hop relay cellular network, the method comprising the steps of:
transmitting a ranging signal to a base station (BS);
transmitting a downlink (DL) subframe to mobile stations (MS) after the transmission of the ranging signal;
transmitting uplink (UL) subframe to the BS after the transmission of the DL subframe; and
switching into a receiving (RX) mode after the transmission of the UL bursts.

21. The method of claim 20, wherein the DL subframe includes an RS preamble and a DL burst.

22. The method of claim 21, wherein the RS preamble and the DL bursts are transmitted sequentially.

23. The method of claim 20, wherein the UL subframe includes BS UL bursts.

24. A method for transmitting signals from a relay station (RS) in a frequency division multiplexing (FDM) multi-hop relay cellular network, the method comprising the steps of:
transmitting a ranging signal to a base station (BS);
transmitting a preamble signal to a mobile station (MS) after the transmission of the ranging signal;
after the transmission of the preamble signal, transmitting an uplink (UL) subframe and a downlink (DL) subframe respectively to the BS and the MS on an FDM basis; and
switching into a receiving (RX) mode after the transmission of the UL subframe and the DL subframe.

25. The method of claim 24, wherein the UL subframe and the DL subframe are simultaneously transmitted using different frequencies.

26. A method for transmitting signals from a base station (BS) in a multi-hop relay cellular network, the method comprising the steps of:
constructing a downlink (DL) subframe to be transmitted to a relay station (RS) and a mobile station (MS) connected through a direct link to the BS and transmitting the DL subframe; and
switching into a receiving (RX) mode after the transmission of the DL subframe.

27. The method of claim 26, wherein the DL subframe includes a preamble, control information and data.

28. The method of claim 27, wherein the preamble, the control information and the data are transmitted sequentially.

29. The method of claim 26, wherein the DL subframe is allocated a two-dimensional burst for transmitting data to the MS and the RS.

30. A method for receiving signals at a base station (BS) in a multi-hop relay cellular network, the method comprising the steps of:
detecting a receiving (RX) start section and a start point of an uplink (UL) subframe transmitted from a relay station (RS) and a mobile station (MS), when a ranging signal is received from the RS and the MS;
receiving the UL subframe if the start point is less than the RX start section; and
switching into a transmission (TX) mode after the receipt of the UL subframe.

31. The method of claim 30, wherein the uplink subframe is received from the RS and is allocated a burst on a time priority basis.

32. A method for transmitting signals from a mobile station (MS) communicating with a relay station (RS) in a multi-hop relay cellular network, the method comprising the steps of:
transmitting an uplink (UL) subframe to the RS;
transmitting a ranging signal to the RS after the transmission of the UL subframe; and
switching into a receiving (RX) mode after the transmission of the ranging signal.

33. The method of claim 32, wherein the UL subframe includes a plurality of UL subframes for a plurality of RSs.

34. A method for receiving signals at a mobile station (MS) communicating with a relay station (RS) in a multi-hop relay cellular network, the method comprising the steps of:
receiving a preamble from the RS to obtain synchronization;
receiving a downlink (DL) subframe from the RS to detect DL data after obtaining synchronization; and
switching into a transmission (TX) mode after detecting the DL data.

35. The method of claim 34, wherein the DL subframe includes a plurality of DL subframe such that the RSs can transmit data through respective links of the RSs.

36. A method for transmitting signals from a mobile station (MS) connected through a direct link to a base station (BS) in a multi-hop relay cellular network, the method comprising the steps of:
transmitting a ranging signal to the BS;
transmitting an uplink (UL) subframe to the BS after the transmission of the ranging signal; and
switching into a receiving (RX) mode after the transmission of the UL subframe.

37. A method for receiving signals at a mobile station (MS) connected through a direct link to a base station (BS) in a multi-hop relay cellular network, the method comprising the steps of:
receiving a preamble from the BS to obtain synchronization;
sequentially receiving control information and a DL burst from the BS after obtaining the synchronization; and
switching into a transmission (TX) mode after receiving the control information and the DL burst.

38. The method of claim 37, wherein the BS DL subframe includes a BS preamble, control information and DL data.

39. The method of claim 38, wherein the BS preamble, the control information and the DL data are received sequentially.

40. The method of claim 37, wherein the DL subframe is allocated a two-dimensional burst for transmitting data to the MS and the BS.

41. A method for constructing a frame for supporting a relay service in a multi-hop relay cellular network, the method comprising the steps of:
constructing a first subframe for performing a receiving (RX) operation of a relay station (RS) during a first section of the frame; and
constructing a second subframe for performing a transmission (TX) operation of an RS during a second section of the frame.

42. The method of claim 41, wherein the first section includes a downlink (DL) subframe transmitted from a base station (BS) to the RS and a mobile station (MS) and an uplink (UL) subframe transmitted from the MS to the RS.

43. The method of claim 42, wherein the DL subframe includes a preamble, control information and a DL burst.

44. The method of claim 42, wherein the UL subframe includes a UL burst and a ranging signal.

45. The method of claim 44, wherein the ranging signal is located in an end region of the UL subframe.

46. The method of claim 41, wherein the second section includes a ranging signal transmitted from the RS and the MS to the BS, a downlink (DL) subframe transmitted from the RS to the MS, and an uplink (UL) subframe transmitted from the RS and the MS to the BS.

47. The method of claim 46, wherein the DL subframe includes a preamble and a DL burst.

48. The method of claim 47, wherein the preamble is located in a start region of the DL subframe.

49. The method of claim 46, wherein the UL subframe includes a UL burst.

50. The method of claim 41, wherein a guard region is interposed between the RX and TX sections for the RS.

51. The method of claim 41, wherein the first section includes a downlink (DL) subframe and an uplink (UL) subframe that are multiplexed on a time-division multiplexing (TDM) basis, and the second section includes a DL subframe and a UL subframe that are multiplexed on a time-division multiplexing (TDM) or a frequency-division multiplexing (FDM) basis.
